(19) United States
(12) Patent Application Publication
(10) Pub. No.: US 2016/0355054 A1
(43) Pub. Date: Dec. 8, 2016

(54) Hybrid Axle Housing

(71) Applicant: CATERPILLAR INC., Peoria, IL (US)

(72) Inventors: Jeffrey E. Jensen, Dunlap, IL (US); Jacob C. Wyss, Eureka, IL (US)

(73) Assignee: CATERPILLAR INC., Peoria, IL (US)

(21) Appl. No.: 14/728,748

(22) Filed: Jun. 2, 2015

(51) Int. Cl. B60B 35/16; B23P 15/14; E02F 9/20; B60K 17/16

(52) U.S. Cl. CPC B60B 35/16; B60K 17/165; B23P 15/14; E02F 9/202; B60B 2360/102; B60B 2360/147; B60B 2310/202; B60B 2310/302

(57) ABSTRACT

An axle housing for a machine may comprise a center housing configured to accommodate a differential housing and bevel gears, and arm portions fixedly attached to the center housing and configured to accommodate an axle. The center housing may be formed from solution strengthened ferritic (SSF) ductile iron.

### TECHNICAL FIELD

The present disclosure generally relates to axle housings and, more specifically, to cost-effective hybrid axle housings formed from separate segments made from different materials that are welded together.

### BACKGROUND

Axle housings for machines support axle shafts that drive the wheels as well as gearing such as bevel gears and a differential that transmit torque from an input drive shaft to the rear axles. For example, the differential may be a bevel planetary gear train that may control the relative rotation rate of the rear wheels during machine turning. Rear axle housing designs may include a central portion that houses the bevel gears and the differential, and hollow, tubular end portions that extend laterally from the central portion to house the rear axles. In addition, attached to the end portions may be flanges that connect directly to the rear wheels (for automobile applications) or to final drive assemblies that drive the rear wheels (for heavy machine applications such as wheel loaders, tractors, excavators, etc.). Given the complex geometry of the bevel gears and differential compared to the rear axle shafts, the central portion of the rear axle housing may have a much more complex geometry than the end portions and may be more difficult to mold, fabricate or otherwise form into a desired structure.

Current rear axle housings for heavy machines may be formed from a single piece of cast ductile iron that includes the central portion, the end portions, and wheel flanges as one piece. However, large one piece casting constructions such as these may have low production volumes and may be expensive to manufacture. Moreover, ductile iron may be difficult or impossible to weld, precluding alternative designs in which the rear axle housing is formed in multiple segments that are later joined together by welding.

U.S. Pat. No. 1,621,007 that issued to Henry Ford on Mar. 15, 1927 discloses a cost-effective rear axle housing in which the rear axle housing is formed in sections that are then welded together. Specifically, the rear axle housing disclosed therein includes a central portion segment and two end portion segments that are welded together. The central portion is formed from one or two pieces of material such as iron, and the two end portions are formed from other pieces of material. While effective, further design improvements for rear axle housings are still wanting, specifically for earth moving machines with more complicated axle housing configurations, namely more complicated earth moving machine axle configurations that accommodate final drives on the ends.

Clearly, there is a need for more cost-effective designs for rear axle housings for a variety of applications.

### SUMMARY

In accordance with one aspect of the present disclosure, an axle housing for a machine is disclosed. The axle housing may comprise a center housing configured to accommodate a differential housing and bevel gears, and arm portions fixedly attached to the center housing and configured to accommodate an axle. The center housing may be formed from solution strengthened ferritic (SSF) ductile iron.

In accordance with another aspect of the present disclosure, a machine is disclosed. The machine may comprise an engine, a plurality of front wheels, a plurality of rear wheels, an axle operatively associated with one of the plurality of front and rear wheels, a differential housing and bevel gears operatively associated with the axle, and final drive assemblies operatively associated with the axle and configured to drive the wheels. The machine may further comprise an axle housing including a center housing accommodating the differential housing and the bevel gears, and arm portions fixedly attached to the center housing and accommodating the axle. The center housing and the arm portions may be separate pieces that are joined together with weld joints. The center housing may be formed from solution strengthened ferritic (SSF) ductile iron.

In accordance with another aspect of the present disclosure, a method of fabricating an axle housing for a machine is disclosed. The axle housing may include a center housing configured to accommodate a differential housing and bevel gears, arm portions attached to the center housing and configured to accommodate an axle, and a flange attached to each of the arm portions and configured to mount a final drive assembly. The method may comprise casting the center housing from solution strengthened ferritic (SSF) ductile iron, casting the flanges from SSF ductile iron, and forming the arm portions from carbon steel tubes. The method may further comprise welding each of the arm portions to the center housing, and welding each of the flanges to one of the arm portions.

These and other aspects and features of the present disclosure will be more readily understood when read in conjunction with the accompanying drawings.

### BRIEF DESCRIPTION OF THE DRAWINGS

FIG. 1 is a perspective view of a machine, constructed in accordance with the present disclosure.

FIG. 2 is a perspective view of a rear axle housing of the machine connected to final drive assemblies and an oscillation joint, constructed in accordance with the present disclosure.

FIG. 3 is a cross-sectional view through the line 3-3 of FIG. 2, constructed in accordance with the present disclosure.

FIG. 4 is a cross-section view of the rear axle housing, illustrating a differential housing and bevel gears inside of a center housing of the rear axle housing, constructed in accordance with the present disclosure.

FIG. 5 is a front perspective view of the rear axle housing in isolation, constructed in accordance with the present disclosure.

FIG. 6 is rear perspective view of the rear axle housing, constructed in accordance with the present disclosure.

FIG. 7 is an exploded view of the rear axle housing, constructed in accordance with the present disclosure.

FIG. 8 is a cross-sectional view through the line 8-8 of FIG. 5, constructed in accordance with the present disclosure.

FIG. 9 is a flowchart of a series of steps that may be involved in fabricating the rear axle housing, in accordance with a method of the present disclosure.

### DETAILED DESCRIPTION

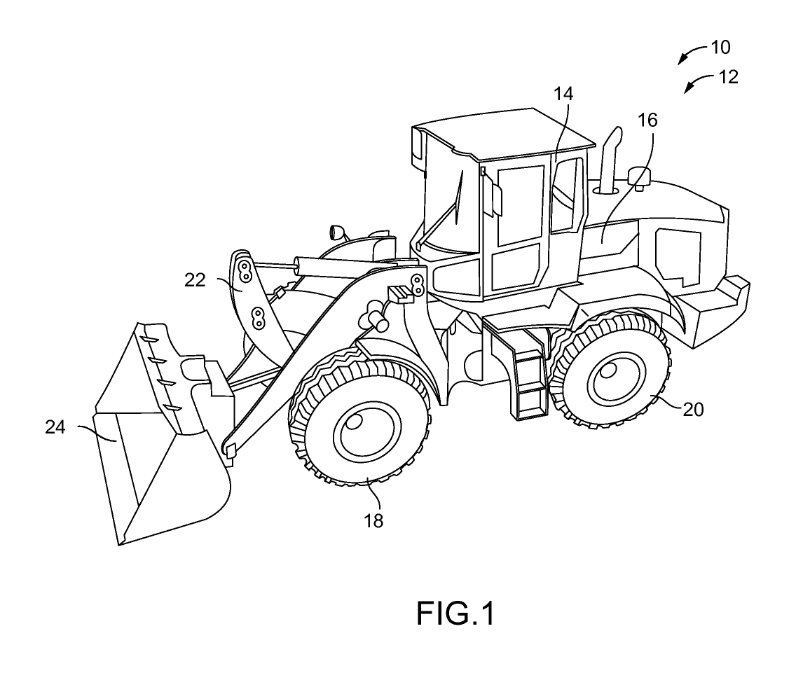

Referring now to the drawings, and with specific reference to FIG. 1, a machine 10 is shown. The machine 10 may be a heavy machine involved in earth moving, material moving, construction, or mining. For example, the machine may be a wheel loader 12, a tractor, an excavator, a large truck, and the like. Alternatively, the machine 10 may be a smaller machine such as an automobile or a small truck, among other types of machines. In general, the machine 10 may include an operator cab 14, an engine 16, and a plurality of front wheels 18 and rear wheels 20 powered by the engine 16 via a drivetrain (see below). In addition, if the machine 19 is a wheel loader 12, it may also include a boom assembly 22 and a bucket 24 for earth or material moving applications.

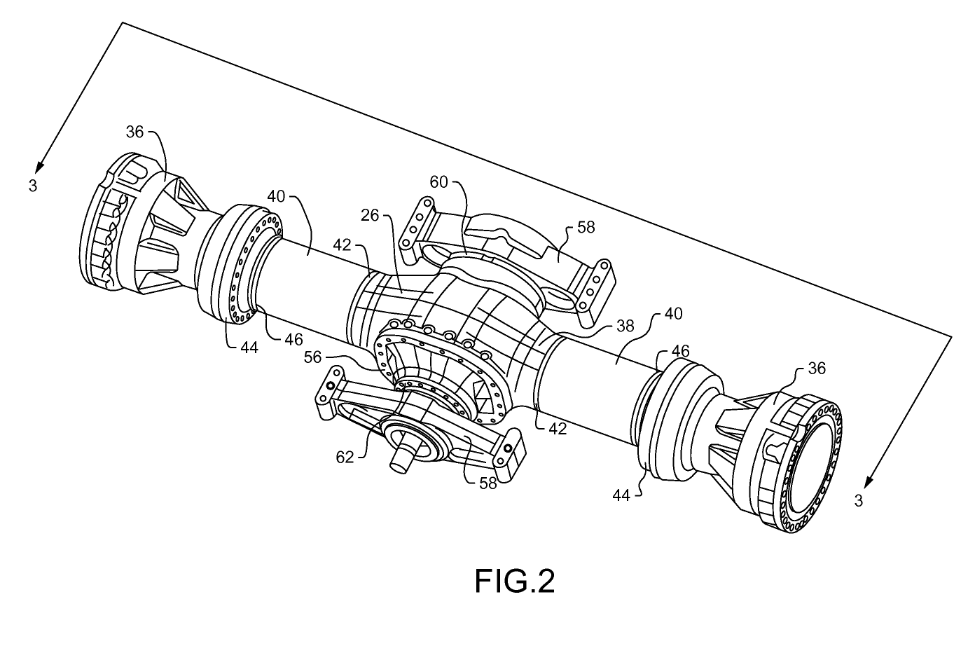

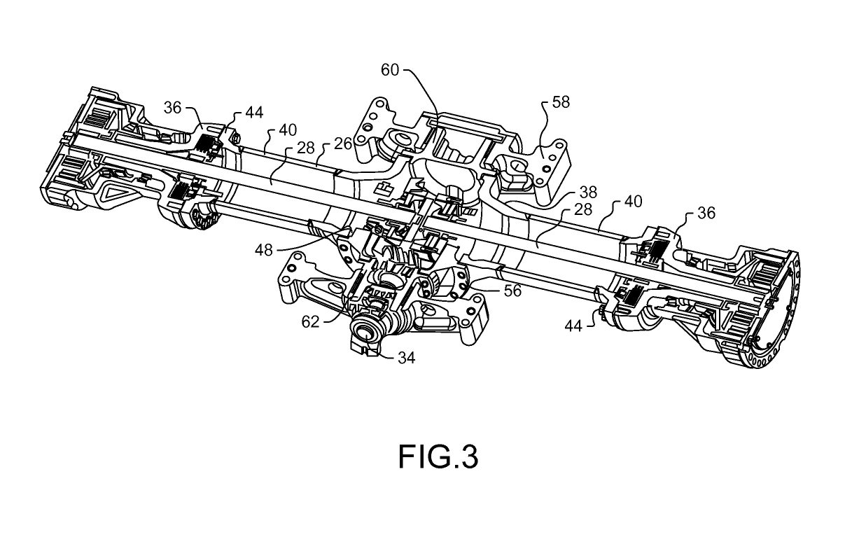

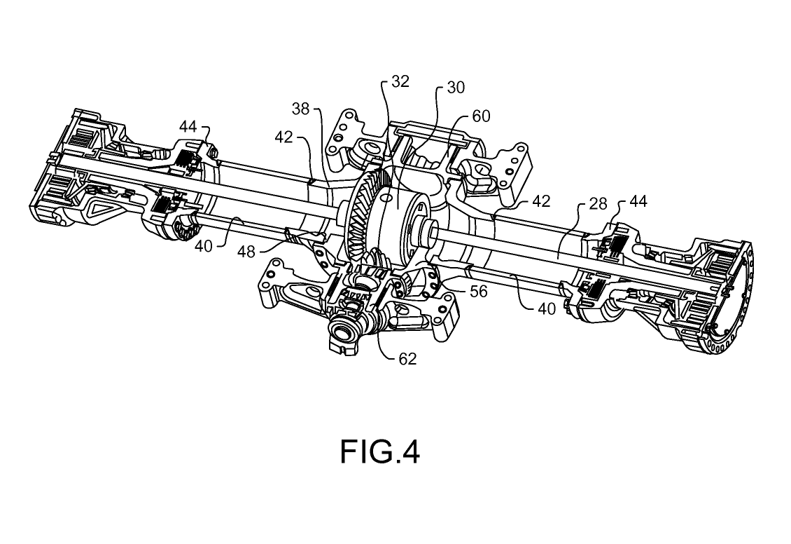

Turning now to FIGS. 2-4, an axle housing 26 of the machine 10 is shown, specifically a rear axle housing. However, the teachings of the present disclosure may be applied with equal efficacy with front or other axles having a differential. The rear axle housing 26 may house a portion of the drivetrain that drives the rear wheels 20. In particular, the rear axle housing 26 may house rear axles 28 (see FIG. 3) as well as a differential housing 30 and bevel gears 32 that transmit torque from an input drive shaft 34 to the rear axles 28 (see FIG. 4). The differential housing 30 may house a differential that may be a planetary gear train that controls the relative rotation rate of the rear wheels 20 when the machine 10 is turning. In addition, each of the rear axles 28 may connect at a laterally outward end to a final drive assembly 36 that may connect to and drive the rear wheels 20. In particular, the final drive assemblies 36 each provide another gear set that reduces speed and increases torque to the rear wheels 20.

The rear axle housing 26 may include a center housing 38 that accommodates the bevel gears 32 and the differential housing 30, as well as hollow tubular arm portions 40 that extend laterally from the center housing 38 and accommodate the rear axles 28 (see FIGS. 3-4). Specifically, the rear axle housing 26 may include two arm portions 40 fixedly attached to and extending from opposing sides 42 of the center housing 38. The rear axle housing 26 may further include flanges 44 fixedly attached to outer ends 46 of each of the arm portions 40. Each of the flanges 44 may mount one of the final drive assemblies 36, as best shown in FIG. 2. This is in contrast to automobile applications, in which there are no corresponding flanges of the rear axle housing as there are no final drives that connect to the rear wheels.

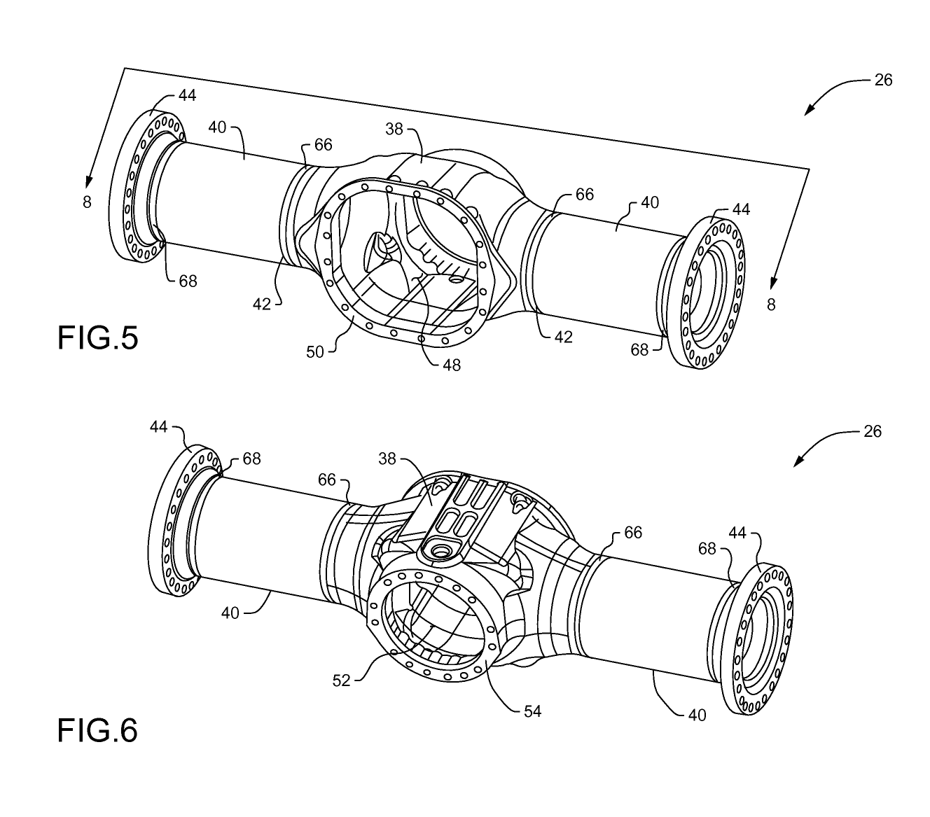

The center housing 38 may also include a front opening 48 having a front flange 50, and a rear opening 52 having a rear flange 54 (see FIGS. 5-6). The input drive shaft 34 may feed into the front opening 48 of the center housing 38 (see FIGS. 3-4), and the front flange 50 may connect to a differential carrier 56 (see FIGS. 2-4). Moreover, the rear flange 54 may connect to half of an oscillation joint 58 via a trunnion 60, and the differential carrier 56 may connect to the other half of the oscillation joint 58 via another trunnion 60. As is well-understand by those with ordinary skill in the art, the oscillation joint 58 and trunnions 60 and 62 may hingedly connect to the machine 10 to assist in preventing tipping of the machine 10 when driving on uneven ground.

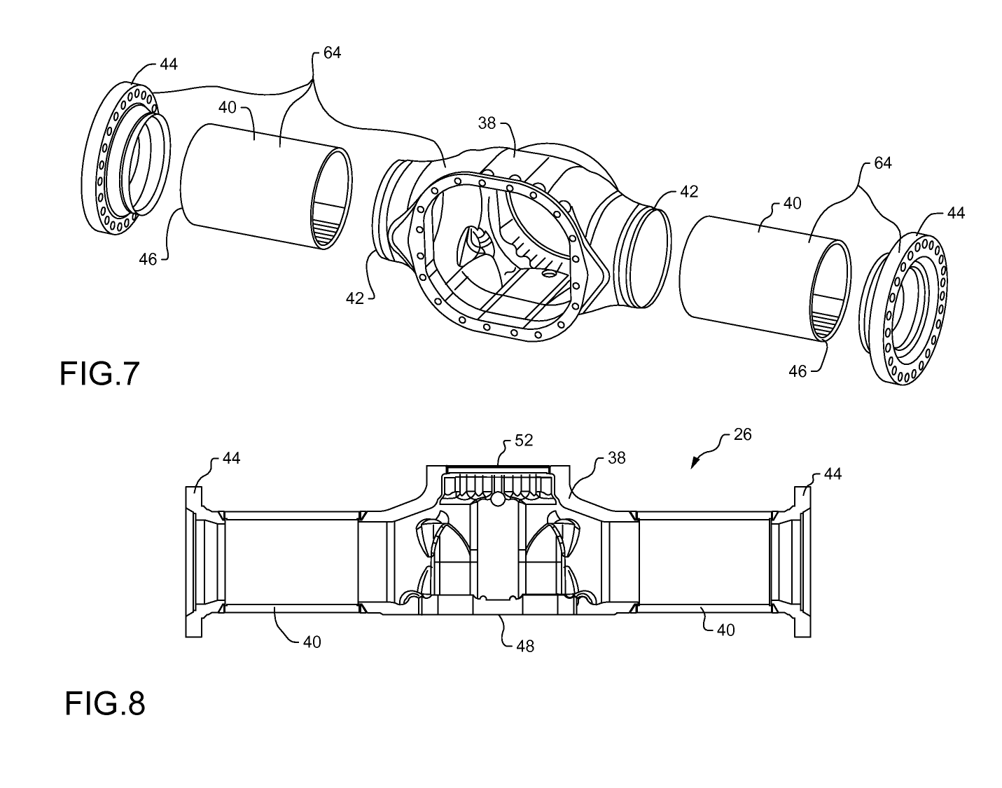

Referring now to FIGS. 5-8, the rear axle housing 26 is shown in isolation. As opposed to a one-piece ductile iron or gray iron casting of the prior art, the rear axle housing of the present disclosure may be formed as separate pieces 64 that are joined together by welding (see FIG. 7). In contrast to ductile or gray iron, which is difficult to weld, each of the separate pieces 64 may be formed from materials that are readily weldable. In one aspect of the present disclosure, the center housing 38, each of the arm portions 40, and each of the flanges 44 may be formed separately (see FIG. 7), although the rear axle housing 26 may be formed in more or less pieces as well. In addition, the rear axle housing 26 may have a hybrid construction in which the separate pieces 64 may be formed from different materials (see below).

In one arrangement, the center housing 38 and the flanges 44 may be formed from solution strengthened ferritic (SSF) ductile iron. The use of SSF ductile iron offers many advantages over traditional ductile iron of the prior art. In particular, SSF ductile iron is stronger than traditional ductile iron due to its higher silicon content. Furthermore, unlike traditional ductile iron, SSF ductile iron is weldable to various metals, such as carbon steel. This property results from the fact that SSF ductile iron is void of copper which generally impedes weldability. In addition, SSF ductile iron is readily moldable into complex shapes by casting processes. Thus, the use of SSF ductile iron instead of traditional ductile iron for the center housing 38 will not interfere with the ability to mold the center housing in a complex geometry necessary to accommodate the bevel gears 32 and the differential housing 30.

Various SSF ductile iron formulas/grades may be used to fabricate the center housing 38 and the flanges 44. Three possible examples of SSF ductile iron formulas and their corresponding properties (tensile strength, yield strength, and elongation) are shown in Table 1 below, although other SSF ductile iron formulas may certainly be used as well. Table 2 shows the composition and properties of a typical traditional ductile iron formula for comparison. As can be seen from Tables 1-2, traditional ductile iron has a silicon content of less than 2.8%, whereas the SSF ductile iron formulas contain more than 3% silicon. Furthermore, traditional ductile iron may contain copper that hinders weldability, whereas SSF ductile iron may be void of copper. It is also noted that the strength of SSF ductile iron (as measured by tensile strength and yield strength) is higher than the ductile iron, and increases steadily with increasing silicon content within a range. In this regard, the strength of the center housing 38 and flanges 44 may be tuned for the application at hand by selection of a SSF ductile iron formula.

TABLE 1
Examples of SSF ductile iron formulas (excluding iron)^{a}

| Element or Property | Formula 1 | Formula 2 | Formula 3 |
|---|---|---|---|
| Carbon | 3.05%-3.45% | 2.85%-3.25% | 2.65%-3.05% |
| Manganese | 0.50% MAX | 0.50% MAX | 0.50% MAX |
| Silicon | 3.05%-3.35% | 3.65%-3.95% | 4.15%-4.45% |
| Phosphorus | 0.05% MAX | 0.05% MAX | 0.05% MAX |
| Sulfur | 0.025% MAX | 0.025% MAX | 0.025% MAX |
| Chromium | 0.10% MAX | 0.10% MAX | 0.10% MAX |
| Titanium | 0.025% MAX | 0.025% MAX | 0.025% MAX |
| Magnesium | 0.06%-0.20% | 0.06%-0.20% | 0.06%-0.20% |
| Tensile strength | 420 MPa | 460 MPa | 560 MPa |
| Yield strength (0.2% | 340 MPa | 390 MPa | 430 MPa |
| offset) | | | |
| Elongation in 50 mm | 12% | 10% | 6% |

^{a}MAX = maxiumum;
MPa = megapascals

TABLE 2
Example ductile iron formula (excluding iron)^{a}

| Element or Property | |
|---|---|
| Carbon | 3.5%-3.9% |
| Silicon | 2.0%-2.8% |
| Manganese | 0.60% MAX |
| Sulfur | 0.025% MAX |
| Phosphorus | 0.05% MAX |
| Chromium | 0.10% MAX |
| Copper | 0.80% MAX |
| Tin | 0.05% MAX |
| Titanium | 0.025% MAX |
| Magnesium | 0.02-0.60% |
| Tensile strength | 415 MPa |
| Yield strength | 275 Mpa |
| Elongation | 10% |

^{a}MAX = maxiumum;
MPa = megapascals

The center housing 38 and the flanges 44 may be cast molded from SSF ductile iron into a desired shape. For the casting process, molten SSF ductile iron may be poured into a cavity of a mold having a shape of the desired center housing 38 or flange 44. The molten SSF ductile iron may then be allowed to solidify and may be removed from the cavity to provide the center housing 38 or the flange 44.

The arm portions 40 of the rear axle housing 26 may be metallic tubes, such as carbon steel tubes. As will be understood by those with ordinary skill in the art, carbon steel is an alloy of iron and carbon, wherein carbon is present in a range of 0.03% to 2.0%. Other elements may certainly be included in various percentages to change the properties of the carbon steel.

In one aspect of the present disclosure, the carbon steel tubes for the arm portions 40 may be purchased from a commercial supplier and cut to a desired length. Alternatively, the carbon steel tubes may be used directly as the arm portions 40 if the carbon steel tubes are already provided with appropriate dimensions. As another alternative, the arm portions 40 may be fabricated from carbon steel using suitable techniques such as, but not limited to, extrusion, cold-working, casting, or forging. The use of commercially available carbon steel as the arm portions 40 of the rear axle housing 26 may significantly reduce manufacturing costs by reducing the size and number of the pieces 64 of the rear axle housing 26 that are made by cast molding.

The separate pieces 64, including the center housing 38, the flanges 44, and the arm portions 40 may be joined together by a suitable welding method, such as, but not limited to, arc welding (for example, stick or wire-feed), friction welding or laser welding. The SSF ductile iron material of the center housing 38 and the flanges 44 may be readily weldable to the carbon steel material of the arm portions 40, thereby facilitating the final assembly of the separate pieces 64 into the rear axle housing 26. Specifically, the two arm portions 40 may each be joined to a respective one of the opposing sides 42 of the center housing 38 with weld joints 66 (see FIGS. 5-7). In addition, each of the two flanges 44 may be joined to a respective one of the two outer ends 46 of the arm portions 40 with weld joints 68 (see FIGS. 5-7).

It is further noted that alternative arrangements of the rear axle housing 26 as disclosed herein may use alternative material constructions for the center housing 38, the arm portions 40, and the flanges 44. For example, the flanges 44 may be formed from a different weldable material than SSF ductile iron, or the arm portions 40 may be formed from a different material than carbon steel. Furthermore, depending on the application, the rear axle housing 26 may have alternative structural arrangements, such as alternative part connections to the center housing 38, or alternative numbers or structures of the arm portions 40 and the flanges 44. Variations such as these fall within the scope and spirit of the present disclosure.

### INDUSTRIAL APPLICABILITY

The teachings of the present disclosure may find industrial applicability in a variety of settings such as, but not limited to, heavy vehicle applications. The hybrid rear axle housing disclosed herein may be formed from multiple separate pieces that are welded together to provide the final structure. Specifically, the center housing that supports the bevel gears and the differential gears may be formed from cast SSF ductile iron, while the arm portions that support the axles may be formed from carbon steel tubes. In addition, the flanges that attach to the arm portions and mount to the final drive assemblies may also be formed from SSF ductile iron.

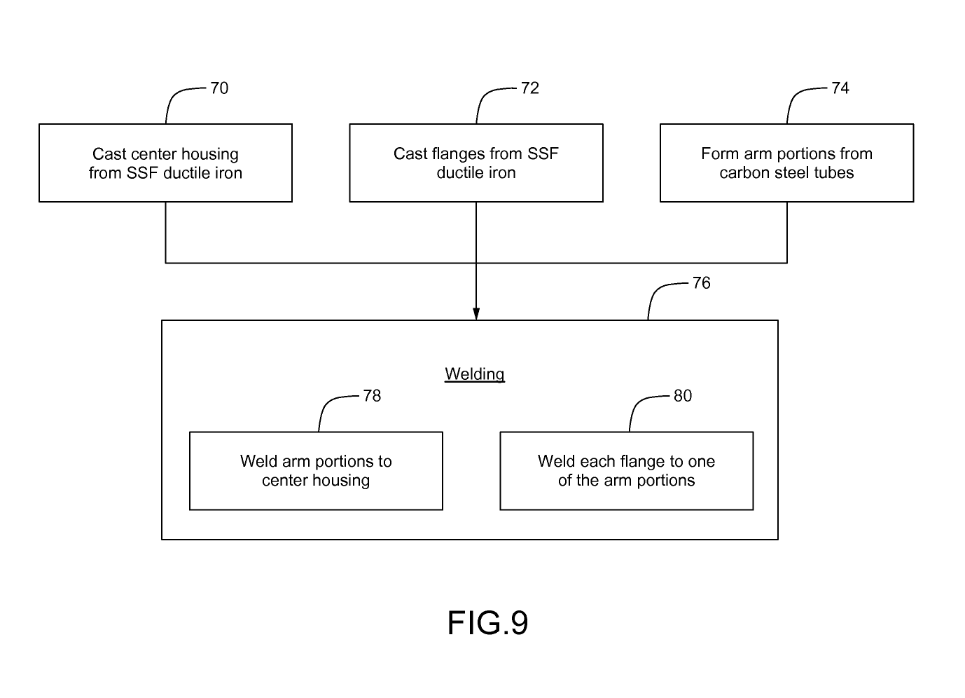

A series of steps that may be involved in the fabrication of the rear axle housing 26 of the present disclosure is shown in FIG. 9. The fabrication of each of the separate pieces 64 (i.e., the center housing 38, the flanges 44, and the arm portions 40 ) may be carried out by the blocks 70, 72, and 74 in any order. The block 70 may include casting the center housing 38 from SSF ductile iron in a desired complex shape suitable to support the bevel gears 32 and the differential housing 30. In addition, the block 72 may involve casting each of the flanges 44 individually from SSF ductile iron, and the block 74 may involve forming the arm portions 40 from carbon steel tubes. It will be understood that the block 74 may include either obtaining the carbon steel tubes from a commercial supplier and cutting the tubes to an appropriate size or using them directly, or fabricating the carbon steel tubes using a suitable metallurgical process.

According to a block 76, the separate pieces 64 may be joined together by welding to provide the final housing 26. Namely, the block 76 may include a block 78 and a block 80 that may be performed in any order. The block 78 may involve welding the arm portions 40 to the center housing 38. Specifically, the block 78 may be carried out by welding each of the arm portions 40 to a respective one of the opposing sides 42 of the center housing 38. In addition, each of the flanges 44 may be welded to a respective one of the outer ends 46 of the arm portions 40 according to the block 80.

The substitution of traditional ductile iron with SSF ductile iron for casting the center housing as disclosed herein may not interfere with the ability to form the center housing in a complex geometry, as SSF ductile iron may be cast into a variety of complex shapes. Furthermore, the use of SSF ductile iron may have several advantages over traditional ductile iron of the prior art. In particular, SSF ductile iron is stronger than traditional ductile iron and is weldable to carbon steel. Indeed, traditional ductile iron could not be used as the center housing in the hybrid rear axle housing construction disclosed herein because it is not weldable to carbon steel. In addition, the fabrication of the rear axle housing from separate pieces that are welded together may significantly reduce manufacturing costs compared to large one-piece cast ductile iron rear axle housings of the prior art. Initial cost estimates show a significant cost reduction in manufacturing costs for the hybrid rear axle housing disclosed herein compared to current one-piece cast ductile iron housings. The rear axle housing disclosed herein may also be significantly lighter in weight than one-piece cast ductile iron housings. Furthermore, the rear axle housing design of the present disclosure may allow modular building of the rear axle housing, in which separate pieces of the rear axle housing are selected and assembled based on size or other properties according to the application at hand. It is expected that the technology disclosed herein may find wide industrial applicability in a wide range of areas such as, but not limited to, heavy vehicle applications such as wheel loaders, tractors, excavators, and large trucks.

What is claimed:

1. An axle housing for a machine, comprising:
a center housing configured to accommodate a differential housing and bevel gears; and
arm portions fixedly attached to the center housing and configured to accommodate an axle, the center housing being formed from solution strengthened ferritic (SSF) ductile iron.

2. The axle housing of claim 1, wherein the center housing is cast molded as a separate piece from the arm portions.

3. The axle housing of claim 2, wherein each of the arm portions is a carbon steel tube.

4. The axle housing of claim 3, further comprising a flange fixedly attached to each of the arm portions.

5. The axle housing of claim 4, wherein each of the flanges is formed from SSF ductile iron.

6. The axle housing of claim 5, wherein each of the flanges is cast molded as a separate piece from the center housing and the arm portions.

7. The axle housing of claim 6, wherein the center housing, the arm portions, and the flanges are joined together with weld joints.

8. The axle housing of claim 7, wherein the axle housing is a rear axle housing.

9. The axle housing of claim 8, wherein each of the flanges is configured to mount a final drive assembly.

10. The axle housing of claim 9, wherein the SSF ductile iron is void of copper and contains more than about 3% silicon.

11. A machine, comprising:
an engine;
a plurality of front wheels;
a plurality of rear wheels;
an axle operatively associated with one of the plurality of front and rear wheels;
a differential housing and bevel gears operatively associated with the rear axle;
final drive assemblies operatively associated with the axle and configured to drive the wheels; and
an axle housing including a center housing accommodating the differential housing and the bevel gears, and arm portions fixedly attached to the center housing and accommodating the axle, the center housing and the arm portions being separate pieces that are joined with weld joints, the center housing being formed from solution strengthened ferritic (SSF) ductile iron.

12. The machine of claim 11, wherein the center housing is cast molded.

13. The machine of claim 12, wherein each of the arm portions is a carbon steel tube.

14. The machine of claim 13, further comprising a flange fixedly attached to each of the arm portions.

15. The machine of claim 14, wherein each of the flanges is formed from SSF ductile iron.

16. The machine of claim 15, wherein each of the flanges is cast molded as a separate piece from the center housing and the arm portions.

17. The machine of claim 16, the flanges are joined to the arm portions with weld joints.

18. The machine of claim 17, wherein each of the flanges mounts one of the final drive assemblies.

19. The machine of claim 18, wherein the machine is a wheel loader.

20. A method of fabricating an axle housing for a machine, the axle housing including a center housing configured to accommodate a differential housing and bevel gears, arm portions attached to the center housing and configured to accommodate an axle, and a flange attached to each of the arm portions and configured to mount a final drive assembly, the method comprising:
casting the center housing from solution strengthened ferritic (S SF) ductile iron;
casting the flanges from SSF ductile iron;
forming the arm portions from carbon steel tubes;
welding each of the arm portions to the center housing; and
welding each of the flanges to one of the arm portions.
